(19) United States
(12) Patent Application Publication
(10) Pub. No.: US 2022/0058609 A1
(43) Pub. Date: Feb. 24, 2022

(54) IMAGE ANALYSIS APPARATUS, MONITORING SYSTEM, AND CHECKOUT SYSTEM

(71) Applicant: TOSHIBA TEC KABUSHIKI KAISHA, Tokyo (JP)

(72) Inventor: Yuishi TAKENO, Numazu Shizuoka (JP)

(21) Appl. No.: 17/338,624

(22) Filed: Jun. 3, 2021

(30) Foreign Application Priority Data
Aug. 21, 2020 (JP) 2020-140023

(51) Int. Cl. G06Q 20/20; G07G 1/14; G07G 3/00; G06K 9/00; H04N 7/18

(52) U.S. Cl. CPC G06Q 20/202; G06Q 20/208; G07G 1/14; H04N 7/188; G06K 9/00771; G06K 9/00362; G07G 3/00

(57) ABSTRACT

An image analysis apparatus includes a first interface connectable to a camera configured to capture an image of a predetermined area in which registration and payment processes for one or more commodities to be purchased are performed using a checkout apparatus and a processor. The processor is configured to when the payment process is performed, determine whether an unregistered commodity is present in the area using the image, upon determining that an unregistered commodity is present in the area, determine whether a customer is present in the area, and upon determining that the customer is not present in the area, output an alert signal.

### CROSS-REFERENCE TO RELATED APPLICATION

This application is based upon and claims the benefit of priority from Japanese Patent Application No. 2020-140023, filed Aug. 21, 2020, the entire contents of which are incorporated herein by reference.

### FIELD

Embodiments described herein relate generally to an image analysis apparatus, a monitoring system, and a checkout system.

### BACKGROUND

A self-service register or self-service checkout apparatus is known that allows a customer to register and settle commodities by himself or herself. Such a self-service register can have a function of alerting or otherwise notifying the customer if there remains an unregistered commodity before a shift to a payment processing mode. However, there may be cases where the same customer intends to register and settle some items in two or more separate sale transactions in a back-to-back manner for the purpose of splitting the payments and/or receiving separate receipts for the different transactions (for example, for buying some goods on a business account and others on a personal account or the like).

However, a conventional self-service register outputs an alert if there appears to be any unregistered items when a customer tries to proceed to the payment process. Accordingly, a store clerk has to cancel the alert every time the customer tries to split transactions in this manner, which may decrease customer convenience and/or increase store staffing requirements.

### BRIEF DESCRIPTION OF THE DRAWINGS

FIG. 1 is a block diagram illustrating a checkout system including checkout apparatuses and image analysis apparatuses according to an embodiment.

FIG. 2 is a diagram illustrating the exterior of a checkout apparatus according to an embodiment.

FIG. 3 is a block diagram illustrating a checkout apparatus according to an embodiment.

FIG. 4 is a block diagram illustrating an image analysis apparatus according to an embodiment.

FIG. 5 is a hardware block diagram illustrating an attendant terminal according to an embodiment.

FIG. 6 is a flowchart of an operation performed by a checkout apparatus according to an embodiment.

FIG. 7 is a flowchart of an operation performed by an image analysis apparatus according to an embodiment.

FIG. 8 is a diagram illustrating an alert displayed by an attendant terminal according to an embodiment.

### DETAILED DESCRIPTION

Embodiments described herein provide an image analysis apparatus, a monitoring system, and a checkout system that can appropriately monitor the registration and payment process that may be repeated by a single customer.

According to an embodiment, an image analysis apparatus includes a first interface connectable to a camera configured to capture an image of a predetermined area in which registration and payment processes for one or more commodities to be purchased are performed using a checkout apparatus and a processor. The processor is configured to when the payment process is performed, determine whether an unregistered commodity is present in the area using the image, upon determining that an unregistered commodity is present in the area, determine whether a customer is present in the area, and upon determining that the customer is not present in the area, output an alert signal.

One or more embodiments are explained below with reference to the drawings.

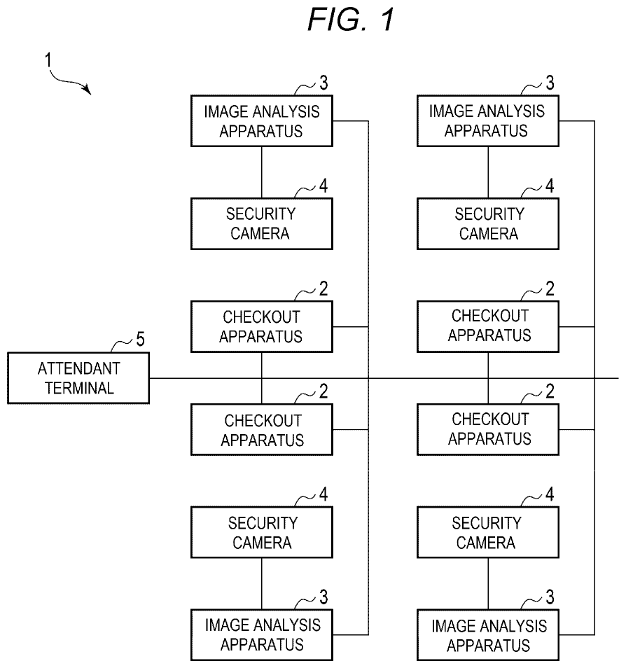

FIG. 1 is a block diagram illustrating a checkout system 1 according to an embodiment.

As illustrated in FIG. 1, the checkout system 1 includes a plurality of checkout apparatuses 2, a plurality of image analysis apparatuses 3, a plurality of security cameras 4, and an attendant terminal 5. In the configuration example illustrated in FIG. 1, the image analysis apparatuses 3 and the attendant terminal 5 make up a monitoring system that monitors, for example, a state of use of each checkout apparatus 2. Each checkout apparatus 2 may including one of the image analysis apparatuses 3.

Each checkout apparatus 2 executes a commodity registration process and a payment process. In an embodiment, the checkout apparatus 2 functions as a self-service checkout apparatus or a self-service register that allows a customer to start the registration process and the payment process for a commodity to be purchased for himself or herself.

Each security camera 4 photographs images for monitoring a state of use of the corresponding checkout apparatus 2, an action of the customer who is operating the checkout apparatus 2, and the like. The security camera 4 is configured to photograph images of a photographing region including a work area in which the customer uses the checkout apparatus 2 to perform the commodity registration or the payment process. The security camera 4 supplies the photographed images of the photographing region including the work area to the corresponding image analysis apparatus 3. One security camera 4 may be provided for each checkout apparatus 2 or may be provided for a predetermined number of checkout apparatuses 2.

The image analysis apparatus 3 analyzes the images photographed by the corresponding security camera 4. The image analysis apparatus 3 executes an analysis process for analyzing, from the photographed images of the security camera 4, the action of the customer of the corresponding checkout apparatus 2, the state of use of the checkout apparatus 2, and the like. The image analysis apparatus 3 outputs an alert according to an analysis result of the state of use of the checkout apparatus 2, the action of the customer, and the like and notifies information indicating the analysis result to the attendant terminal 5 and/or the checkout apparatus 2.

The attendant terminal 5 notifies, to an attendant, information indicating, for example, a state of use of each checkout apparatus 2 set as a monitoring target. The attendant terminal 5 is connected to each checkout apparatus 2 and each image analysis apparatus 3. Two or more checkout apparatuses 2 may be set as monitoring targets at the same time to monitor states of use thereof.

The attendant terminal 5 is connected to a display 90 (see FIG. 5) that displays information indicating the state of use of the checkout apparatus 2 which has been set as the monitoring target. For example, if a plurality of checkout apparatuses 2 are set as monitoring targets, the attendant terminal 5 divides a display screen on the display by the number of the checkout apparatuses 2 being monitored and displays, on the divided screen, information indicating states of use of the individual checkout apparatuses 2, monitoring images, and the like.

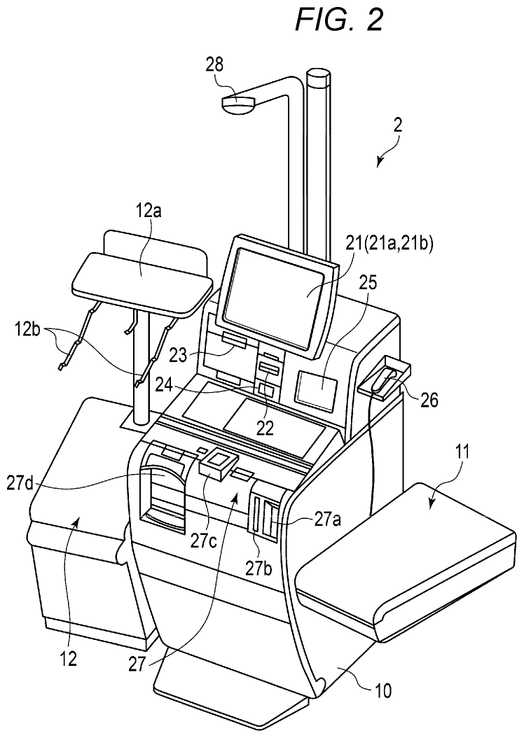

A configuration example of the checkout apparatus 2 is explained with reference to FIG. 2.

FIG. 2 is a diagram illustrating the exterior of the checkout apparatus 2 according to an embodiment.

The checkout apparatus 2 illustrated in FIG. 2 is a self-service checkout apparatus or a self-service register (also may be referred to as a self-server point-of-sale (POS) terminal or the like) that allows a customer to execute the commodity registration process and the payment process by himself or herself.

As illustrated in FIG. 2, a checkout apparatus 2 includes a main body 10 and a first commodity placing table 11 and a second commodity placing table 12 disposed on the right and left sides of the main body 10 when viewed from the customer. In an embodiment, the first commodity placing table 11 is a place on which commodities are placed by the customer before being registered in an item registration process. The commodities after being registered are to be placed on the second commodity placing table 12. However, in some examples, the unregistered commodities may be in another predetermined position other than the first commodity placing table 11, such as such as in a shopping cart (hereinafter, cart) or a shopping basket. In such a case, the predetermined position for the cart or the basket, need only to be within a photographing range of the security camera 4.

The first commodity placing table 11 is disposed on the right side of the main body 10 when viewed from the front side of the main body 10. For example, a basket or a container containing commodities to be purchased by the customer (commodities before the registration process) is placed on the first commodity placing table 11. In some examples, commodities to be purchased by the customer may be directly placed on the first commodity placing table 11. The first commodity placing table 11 can be anywhere within the range permitting the commodities placed on the first commodity placing table 11 to be photographed by the security camera 4.

The second commodity placing table 12 is disposed on the left side of the main body 10 when viewed from the front side of the main body 10. The commodities taken from the first commodity placing table 11 and subjected to the registration process are then placed on the second commodity placing table 12. For example, now-registered commodities (registered commodities), that is, those items for which barcodes have been read/scanned or otherwise identified (e.g., input by user key operation), are to be placed on the second commodity placing table 12. In the configuration example illustrated in FIG. 2, a temporary placement table 12a is provided above the second commodity placing table 12 and is supported by a column. The temporary placement table 12a is used in order to temporarily place commodities before packing/placing those items into a shopping bag. Two holding arms 2b separated to the left and the right are attached to the temporary placement table 12a. The holding arms 2b hold a shopping bag in an open or openable state.

In the main body 10, a display 21, a card reader writer (RW) 22, a printer 23, a speaker 24, a scanner 25, a hand scanner 26 (hand-held type scanner), and a cash processing machine 27 are provided. Further, a camera 28 is provided above the main body 10 and supported by a column.

The display 21 is a touch screen display including a display device 21a and a touch panel 21b. The display device 21a displays operation guidance, icons (e.g., touch keys) selectable by a customer, a message of a warning serving as an alert, or the like. The display device 21a is, for example, an LCD (Liquid Crystal Display). The touch panel 21b detects a touch operation by the customer on the display device 21a. The touch panel 21b outputs information indicating the position where the touch operation has been detected.

For example, the display device 21a displays a GUI (Graphical User Interface) for inputting, through a touch operation by the customer, a selecting instruction for a payment method (e.g., cash or a card) or the like and various kinds of information. The display device 21a displays a guidance screen, an information input screen, a commodity registration screen, a settlement screen, and the like. The guidance screen is a screen for displaying guidance information (e.g., a message) about how to operate the checkout apparatus 2. The information input screen is, for example, an operation screen for manually inputting information concerning a commodity not having a barcode. The commodity registration screen is a screen for displaying information concerning a registered commodity. On the commodity registration screen, for example, information concerning a commodity identified by a barcode read by the scanner 25 or the hand scanner 26, a commodity designated by key operation, and the like is displayed. The settlement screen is a screen for displaying a total amount of registered commodities, a deposit amount, a change amount, and the like in the payment process in which the customer pays prices of the commodities.

The card reader writer (RW) 22 reads/writes data from/to a card. The card reader writer 22 includes a card insertion port. The card reader writer 22 has a function of reading data recorded in the card and a function of writing data in the card. The card reader writer 22 may accept a magnetic card or a contact-type or non-contact-type IC card. The card reader writer 22 may include a mechanism for processing a plurality of different types of cards.

For example, the card reader writer 22 processes a card such as a credit card for settlement or a member card inserted in the card insertion port. For example, a credit card, a debit card, an electronic money card, and a prepaid card may be used for settlement. The member card may store member information, point information usable for settlement, and the like.

The printer 23 prints a receipt. The printer 23 includes a receipt dispensing port. The printer 23 prints various kinds of character strings, images, and the like on receipt paper to thereby dispense it as a receipt. The printer 23 is, for example, a thermal printer or a dot impact printer. For example, if the payment process is completed, the printer 23 issues a receipt on which information related to the transaction is printed and discharges the receipt from the receipt dispensing port.

The speaker 24 outputs a sound such as a warning or alert sound or a voice message.

The scanner 25 and the hand scanner 26 read information for identifying a commodity. In an embodiment, the scanner 25 and the hand scanner 26 read a barcode attached to a commodity as information for identifying the commodity. The scanner 25 optically reads an image of the barcode attached to the commodity held over the scanner 25 by the customer such that the barcode faces the scanner 25. The hand scanner 26 is held and operated by the customer. The hand scanner 26 is brought close to the barcode attached to the commodity to optically read the barcode. The scanner 25 and the hand scanner 26 only have to read the information for recognizing the commodity and may read information other than a barcode.

The cash processing machine 27 accepts and dispenses cash. The cash processing machine 27 includes a bill depositing port, a bill discharging port, a coin depositing port, and a coin discharging port. The cash processing machine 27 processes bills deposited to a bill depositing port 27a. The cash processing machine 27 discharges bills as change from a bill discharging port 27b. The cash processing machine 27 receives and stores coins deposited to a coin depositing port 27c. The cash processing machine 27 discharges coins as change from a coin discharging port 27d.

The camera 28 photographs an image in a photographing range including a region where commodities before the registration process are placed. For example, the photographing range is configured such that the camera 28 can photograph the inside of a basket containing the commodities before the registration process and placed on the first commodity placing table 11. The photographing range may be configured such that the camera 28 can photograph the entire first commodity placing table 11. The photographing range is further configured such that the camera 28 can photograph the inside of a cart containing the commodities before the registration process in a predetermined position. The predetermined position is set, for example, in the vicinity of the first commodity placing table 11.

The camera 28 may be set to take a video of the customer during the commodity registration process and the payment process. In such a case, the camera 28 is set such that the first commodity placing table 11 and the second commodity placing table 12 are included in the photographing range. According to such setting, the camera 28 can take a video until the commodities placed on the first commodity placing table 11 are placed on the second commodity placing table 12. By saving the video by the camera 28 in a storage device 43 or the like, it is possible to use the video to recognize a situation, for example, if an error occurs.

The camera 28 may be used as the security camera 4. If the camera 28 is used as the security camera 4, the camera 28 is set to photograph a photographing range including a work area for the customer to carry out work such as commodity registration and the payment process. If the camera 28 is used as the security camera 4, images photographed by the camera 28 are supplied to the image analysis apparatus 3 as well.

The configuration of the checkout apparatus 2 according to an embodiment is explained.

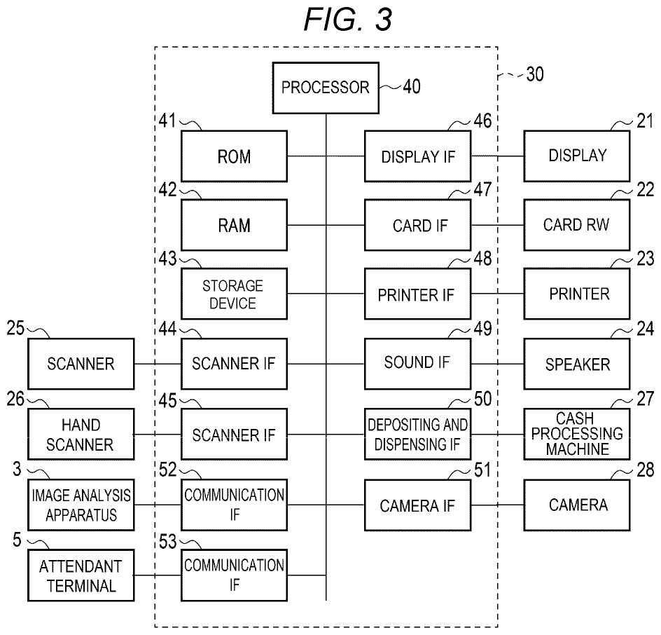

FIG. 3 is a hardware block diagram illustrating the checkout apparatus 2 according to an embodiment.

In the configuration example illustrated in FIG. 3, the main body 10 of the checkout apparatus 2 includes a controller 30. The display 21, the card reader writer 22, the printer 23, the speaker 24, the scanner 25, the hand scanner 26, the cash processing machine 27, the camera 28, and the like are electrically connected to the controller 30. The controller 30 includes a processor 40, a ROM (read-only memory) 41, a RAM (random-access memory) 42, a storage device 43, and various interfaces (IF) 44 to 53.

The processor 40 executes programs to thereby execute various kinds of processing. The processor 40 is, for example, a CPU (central processing unit). The processor 40 executes programs stored in the ROM 41 or the storage device 43 to thereby perform various processing functions. For example, the processor 40 executes a program for the registration process for registering a commodity to be purchased. The processor 40 executes a program for the payment process for settling a price of a purchased commodity.

The ROM 41 is a nonvolatile memory and stores programs and data. For example, the ROM 41 stores programs such as an operating system, middleware, and applications. The ROM may store data that the processor 40 refers to in executing various kinds of processing.

The RAM 42 temporarily stores data as a work area for the processor 40. The RAM 42 stores, as appropriate, data that the processor 40 refers to in executing various kinds of processing, data that the processor 40 temporarily uses, or the like.

The storage device 43 stores programs and data. For example, the storage device 43 is a rewritable nonvolatile memory. The storage device 43 is, for example, an EEPROM® (electric erasable programmable read-only memory), an HDD (hard disk drive), or an SSD (solid state drive). The storage device 43 stores data that the processor 40 uses in executing various kinds of processing or data generated in the processing by the processor. The storage device 43 may store various programs to be executed by the processor 40. For example, the storage device 43 may store the program for the registration process or the program for the payment process.

The RAM 42 and/or the storage device 43 stores information concerning commodities registered in the commodity registration process. The RAM 42 and/or the storage device 43 may store, for example, as data in a list format (hereinafter referred to as a registered commodity list), information concerning the registered commodities. The RAM 42 and/or the storage device 43 stores a photographed image photographed by the camera 28. The storage device 43 may store, for example, video data obtained by adding a time stamp to the image photographed by the camera 28.

The processor 40 is configured to control the scanner 25 via a scanner IF 44. The processor 40 acquires, via the scanner IF 44, an image read by the scanner 25. The processor 40 is configured to control the hand scanner 26 via a scanner IF 45. The processor 40 acquires, via the scanner IF 45, an image read by the hand scanner 26. The processor 40 decodes a barcode included in the image acquired from the scanner 25 or the hand scanner 26 to thereby identify a commodity indicated by the barcode.

The processor 40 is configured to control the display 21 via a display IF 46. The processor 40 acquires, via the display IF 46, information indicating a touch position detected by the touch panel 21b of the display 21. For example, the processor 40 displays, on the display 21, an alert message or an indicator for notifying presence of an unregistered commodity. The processor 40 detects an input selecting icons (or touch keys) displayed on the display 21 according to the information indicating the touched or otherwise selected position.

The processor 40 is configured to control the card reader writer 22 via a card IF 47. The processor 40 controls, via the card IF 47, the card reader writer 22 to perform processing for a card. For example, the processor 40 executes the payment process by a credit card inserted into the card reader writer 22.

The processor 40 is configured to control the printer 23 via a printer IF 48. For example, the processor 40 controls the printer 23 to issue a receipt showing a result of the payment process.

The processor 40 is configured to control the speaker 24 via a sound IF 49. The processor 40 controls, via the sound IF 49, sound output from the speaker 24. For example, the processor 40 controls the speaker 24 to output an alert sound such as a buzzer sound for notifying presence of an unregistered commodity before the payment process.

The processor 40 is configured to control the cash processing machine 27 via a depositing and dispensing IF 50. For example, the cash processing machine 27 counts cash deposited by the customer and the processor 40 acquires a deposited amount counted by the cash processing machine 27. The processor 40 performs control for discharging, with the cash processing machine 27, change calculated from the deposited amount and a total amount of registered commodities.

The processor 40 is configured to control the camera 28 via a camera IF 51. The processor 40 acquires, via the camera IF 51, an image photographed by the camera 28. For example, the processor 40 acquires an image of the inside of a basket or a container placed on the first commodity placing table 11 photographed by the camera 28 before the checkout apparatus 2 executes the payment process. The processor 40 may acquire a plurality of images of the inside of the basket or the container placed on the first commodity placing table 11 photographed by the camera 28 continuously (for example, at a predetermined period) during the registration process.

The processor 40 is configured to communicate with the image analysis apparatus 3 via a communication IF 52. The processor 40 controls the communication IF 52 to transmit information indicating a state of use (for example, proceeding to the payment process) of the checkout apparatus 2 to the image analysis apparatus 3. The processor 40 may acquire, via the communication IF 52, information indicating an analysis result by the image analysis apparatus 3 for an image photographed by the security camera 4.

The processor 40 is configured to communicate with the attendant terminal 5 via a communication IF 53. The processor 40 controls the communication IF 53 to transmit information indicating an operation state to the attendant terminal 5. For example, the processor 40 controls the communication IF 53 to transmit information indicating a state of use such as a registration state of a commodity or an execution state of the payment process by the checkout apparatus 2 to the attendant terminal 5. The processor 40 may be configured to control the communication IF 53 to transmit an alert to the attendant terminal 5 according to a result of an image analysis by the image analysis apparatus 3.

A single communication IF may be provided instead of the communication IF 52 and the communication IF 53. For example, if the checkout apparatus 2 is configured to communicate with the image analysis apparatus 3 and the attendant terminal 5 connected to a network such as a LAN (local area network), the communication IF 52 and the communication IF 53 may be a network interface for performing network communication. If the checkout apparatus 2 and the image analysis apparatus 3 are integrated into one apparatus, the communication IF 52 may be omitted. In such a case, the controller 30 including the processor 40, the ROM 41, and the RAM 42 is further configured to execute an image analysis process by the image analysis apparatus 3 explained below.

The processor 40 may be configured to communicate with a computer such as a management server via the communication IF 52 or 53. For example, the processor 40 controls the communication IF 53 to transmit, to the management server, information indicating a commodity registered by the checkout apparatus 2 or a commodity for which payment is made. The processor 40 may acquire, as appropriate, for example, information concerning a commodity from a store computer with which the processor 40 communicates via the communication IF 53.

The configuration of the image analysis apparatus 3 according to an embodiment is explained.

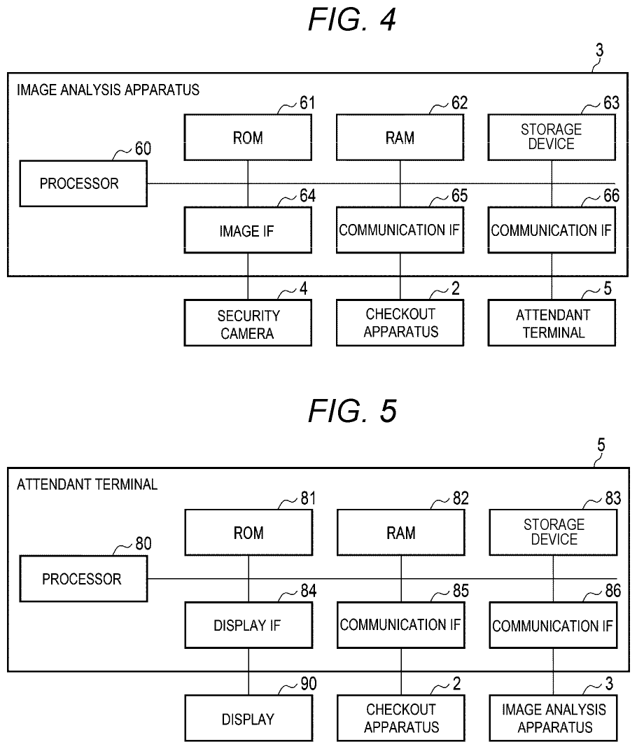

FIG. 4 is a block diagram illustrating the image analysis apparatus 3 according to an embodiment.

In the configuration example illustrated in FIG. 4, the image analysis apparatus 3 is communicatively connected to the security camera 4, the checkout apparatus 2, and the attendant terminal 5. The image analysis apparatus 3 includes a processor 60, a ROM 61, a RAM 62, a storage device 63, an image IF 64, and communication IFs 65 and 66.

The processor 60 executes programs to perform various kinds of processing. The processor 60 is, for example, a CPU. The processor 60 executes programs stored in the ROM 61 and/or the storage device 63 to thereby perform various processing functions. For example, the processor 60 executes a program for an image analysis process for analyzing, for example, a state of use of the checkout apparatus 2 based on an image acquired by the security camera 4. Further, the processor 60 executes a program for detecting the checkout apparatus 2 transitioning to the payment process. The processor 60 executes a program for recognizing presence or absence of a customer in a work area corresponding to the checkout apparatus 2, an action of the customer, or the like.

The ROM 61 is a nonvolatile memory and stores programs and data. For example, the ROM 61 stores programs such as an operating system, middleware, and applications. The ROM may store data that the processor 60 refers to in executing various kinds of processing.

The RAM 62 temporarily stores data as a work area for the processor 60. The RAM 62 stores, as appropriate, data that the processor 60 refers to in executing various kinds of processing, data that the processor 60 temporarily uses, and the like.

The storage device 63 stores programs and data. For example, the storage device 63 is a rewritable nonvolatile memory. The storage device 63 is, for example, an EEPROM®, an HDD, or an SSD. The storage device 63 stores data that the processor 60 uses in executing various kinds of processing or data generated in the processing by the processor 60.

For example, the storage device 63 stores, for a particular period, images photographed by the security camera 4. Further, the storage device 63 stores, among the images photographed by the security camera 4, a series of images determined, by the image analysis process, to be displayed by the attendant terminal 5. The storage device may store various programs to be executed by the processor 60. For example, the storage device 63 may store programs such as a program for the image analysis process, a program for detecting transition to the payment process, and a program for recognizing a movement of a customer.

The processor 60 is configured to control the security camera 4 via an image IF 64. The processor 60 acquires, via the image IF 64, an image photographed by the security camera 4. If the camera 28 included in the checkout apparatus 2 is used as the security camera 4, the processor may acquire, via a communication IF 65, an image photographed by the camera 28 functioning as the security camera 4.

The processor 60 is configured to communicate with the checkout apparatus 2 via the communication IF 65. The processor 60 may acquire, via the communication IF 65, a signal from the checkout apparatus 2 indicating that the checkout apparatus 2 has shifted to the payment process. The processor 60 may control the communication IF 65 to transmit, to the checkout apparatus 2, information indicating a state of a customer (for example, presence or absence of a customer in the work area) obtained as an analysis result of an image photographed by the security camera 4.

The processor 60 is configured to communicate with the attendant terminal 5 via a communication IF 66. The processor 60 controls the communication IF 66 to transmit information obtained as a result of the image analysis process to the attendant terminal 5. For example, if the customer leaves the work area of the checkout apparatus 2 in a state in which an unregistered commodity is left behind, the processor 60 may control the communication IF 66 to transmit an alert (e.g., information indicating that the customer leaves the work area in the state in which the unregistered commodity is left behind) to the attendant terminal 5. The processor 60 may control the communication IF 66 to transmit an image photographed by the security camera 4 to the attendant terminal 5 together with the alert.

Instead of the communication IF 65 and the communication IF 66, a single communication IF may be provided for communicating with the checkout apparatus 2 and the attendant terminal 5 via a network such as a LAN.

The configuration of the attendant terminal 5 according to an embodiment is explained.

FIG. 5 is a hardware block diagram illustrating the attendant terminal 5 according to an embodiment.

In the configuration example illustrated in FIG. 5, the attendant terminal 5 is connected to the display 90. The attendant terminal 5 includes a processor 80, a ROM 81, a RAM 82, a storage device 83, a display IF 84, and communication IFs 85 and 86.

The processor 80 executes programs to perform various kinds of processing. The processor 80 is, for example, a CPU. The processor 80 executes programs stored in the ROM 81 and/or the storage device 83 to thereby perform various processing functions. For example, the processor 80 executes a program for displaying an alert on the display according to alert notification transmitted from the image analysis apparatus 3 and a program for displaying an image photographed by the security camera 4.

The ROM 81 is a nonvolatile memory and stores programs and data. For example, the ROM 81 stores programs such as an operating system, middleware, and applications. The ROM may store data that the processor 80 refers to in executing various kinds of processing.

The RAM 82 temporarily stores data as a work area for the processor 80. The RAM 82 stores, as appropriate, data that the processor 80 refers to in executing various kinds of processing, data that the processor 80 temporarily uses, or the like.

The storage device 83 stores programs and data. The storage device 83 is a rewritable nonvolatile memory. The storage device 83 is, for example, an EEPROM®, an HDD, or an SSD. The storage device 83 stores data that the processor 80 uses in executing various kinds of processing or data generated in the processing by the processor 80. The storage device 83 may store various programs to be executed by the processor 80.

The processor 80 is connected to the display 90 via the display IF 84. The processor 80 controls, via the display IF 86, the display 90 to display information. The display 90 may be a touch screen display. In such a case, the processor 80 may acquire, via the display IF 84, information indicating a touch position detected by a touch panel or sensor. For example, the processor 80 detects an input to icons (e.g., touch keys) displayed on the display according to the information indicating the touch position.

The processor 80 is configured to communicate with the checkout apparatus 2 via the communication IF 85. For example, the processor 80 acquires information related to the commodity registration process or the payment process from the checkout apparatus 2 via the communication IF 85. The processor 80 may acquire, from the checkout apparatus 2, an image photographed by the camera 28.

The processor 80 is configured to communicate with the image analysis apparatus 3 via the communication IF 86. The processor 80 acquires, via the communication IF 86, for example, an alert signal generated by the image analysis process from the image analysis apparatus 3. For example, the processor 80 acquires, via the communication IF 86, an alert signal from the image analysis apparatus 3 indicating that the customer has left the work area while an unpaid commodity is left behind. The processor 80 acquires, via the communication IF 86, an image photographed by the security camera 4 to be displayed in response to the alert signal.

Instead of the communication IF 65 and the communication IF 66, a single communication IF may be provided for communicating with the checkout apparatus 2 and the image analysis apparatus 3 via a network such as a LAN.

An operation example of the checkout apparatus 2 configured as explained above is explained.

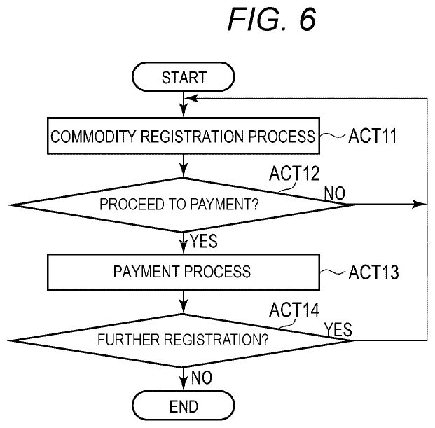

FIG. 6 is a flowchart of an operation including the commodity registration process and the payment process performed by the checkout apparatus 2.

A customer carries a plurality of commodities to be purchased and stands in front of the checkout apparatus 2. The customer sets the commodities to be purchased in a predetermined position. For example, the customer places a basket or a container containing the commodities to be purchased on the first commodity placing table 11. The customer may directly place the commodities to be purchased on the first commodity placing table 11. The customer may instead place a cart containing the commodities to be purchased in a predetermined position. That is, either the first commodity placing table 11 or the predetermined position for the cart may serve as a place for unregistered commodities.

After setting the commodities to be purchased (unregistered commodities) in the commodity placing place, the customer operates the checkout apparatus 2 to start the commodity registration process. For example, the customer touches a touch key displayed on the display 21 to thereby instruct the start of the commodity registration process. The processor 40 may recognize the start of the commodity registration process by detecting a particular behavior of the customer. For example, the processor 40 may analyze images photographed by the camera 28 to thereby detect the behavior of the customer and determine the start of the commodity registration process.

The processor 40 of the checkout apparatus 2 executes, according to the start instruction for the commodity registration process, the commodity registration process for registering commodity information of each target commodity (ACT 11). In the commodity registration process, the processor 40 identifies each individual commodity by a barcode read by the scanner 25 or the hand scanner 26 according to operation by the customer. If a commodity can be identified by a barcode, the processor 40 registers information concerning the identified commodity.

In the registration process, a commodity may be manually registered by a designation by the customer. For example, the processor 40 may operate to register a commodity as designated by the customer selecting a touch key displayed on the display 21. The customer upon deciding that the registration of the items has been completed instructs a shift to the payment process. For example, the customer requests the shift to the payment process by pressing a touch key displayed on the display 21.

If a shift to the payment process (or an end to the commodity registration process) is instructed (YES in ACT 12), the checkout apparatus 2 proceeds to the payment process for the registered commodities. After proceeding to the payment process, the processor 40 executes a payment process for settling the total amount due for all registered commodities (ACT 13). For example, the processor 40 specifies prices of each of the registered commodities and calculates a total amount due based on the prices of the commodities. The processor 40 performs processing for displaying the calculated total amount on the display 21 and then for receiving payment from the customer. If the total amount due for the commodities is received, the processor 40 ends the payment process for the registered items.

Upon ending the payment process for the registered commodities, the processor 40 next determines whether the customer wishes to carry out another (separate) commodity registration and payment process (ACT 14). If a further registration process and payment process for any other commodities is desired, the customer can start the next commodity registration process with a predetermined operation.

For example, the processor 40 accepts a start instruction for a further registration process for the remaining commodities by the customer during fixed predetermined period after the previous payment process has ended. If the start of another registration process is instructed in the predetermined period, the processor 40 returns to ACT 11 and repeats the commodity registration process explained above. If the start of the further registration process is not instructed within the predetermined period, the processor 40 ends a series of processing for the customer.

In some examples, the processor 40 may accept the start instruction for the further registration process until the customer leaves a predetermined region (for example, the work area immediately surrounding the checkout apparatus 2) after the payment process is ended. The processor 40 may detect, from an image photographed by the camera 28, whether the customer leaves the predetermined region or may determine, from an analysis result for an image photographed by the security camera 4 by the image analysis apparatus 3, whether the customer leaves the predetermined region. The processor 40 ends a series of processing for the customer if the customer leaves the predetermined region or if an end instruction for a series of processing by the customer is input.

The operation of the image analysis apparatus 3 according to an embodiment is explained.

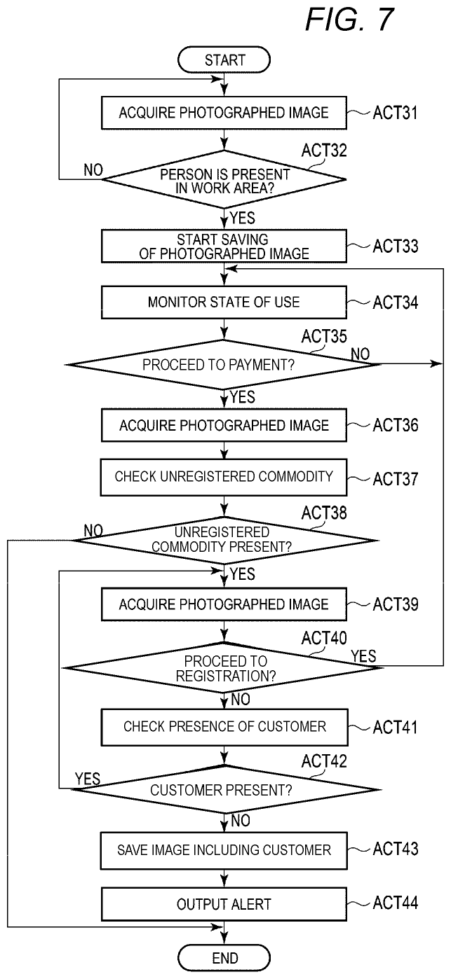

FIG. 7 is a flowchart for explaining an operation including the image analysis process by the image analysis apparatus 3 according to an embodiment.

The processor 60 of the image analysis apparatus 3 acquires, from the security camera 4, via the image IF 64, an image obtained by photographing a photographing range including a work area corresponding to the checkout apparatus 2 set as a monitoring target (ACT 31). The processor 60 determines, based on the photographed image acquired from the security camera 4, whether a person is present in the work area (ACT 32). If a person is absent in the work area around the checkout apparatus 2 (NO in ACT 32), the processor 60 returns to ACT 31 and repeatedly performs the processing in ACT 32.

As the processing in ACT 31, the processor 60 may acquire images photographed by the security camera 4 from when processing for the customer is started in the checkout apparatus 2. As the processing in ACT 32, the processor 60 may detect, using a sensor or the like, that a person is present in the work area or a person enters the work area.

If a person is present in the work area (YES in ACT 32), the processor 60 starts processing for storing an image photographed by the security camera 4 in the storage device (ACT 33). The processor 60 continuously stores images photographed by the security camera 4 in the storage device 63 until the person leaves the work area. The processor 60 saves, for example, information indicating photographing time in the storage device 63 in association with the photographed image to be stored.

However, the processor 60 may store the image photographed by the security camera 4 in the storage device 63 irrespective of presence or absence of a person in the work area. In such a case, the processor 60 only has to record the photographing time in the storage device 63 in association with the photographed image to be stored and further record, in the storage device 63, time when the presence of the person in the work area is detected (corresponding to when the person enters the work area).

The processor 60 monitors the state of use of the checkout apparatus 2 (ACT 34). In an embodiment, the processor 60 checks, according to the monitoring of the state of use, whether the checkout apparatus 2 has shifted to the payment process (ACT 35). For example, the processor 60 may acquire, via the communication IF 66, a signal from the checkout apparatus 2 indicating the transition to the payment process. In such a case, the processor 60 determines, based on the reception of the signal indicating the transition to the payment process, that the checkout apparatus 2 proceeds to the payment process.

The processor 60 may detect, according to an image analysis result of an image photographed by the security camera 4 acquired by the image IF 64, a transition of a screen displayed on the display 21 of the checkout apparatus 2. In such a case, the processor 60 can detect the transition to the payment process by detecting that the screen displayed on the display 21 transitioned to a screen for the payment process.

The processor 60 may recognize a state of work (e.g., an action) of the customer according to the image analysis result of the image photographed by the security camera 4 acquired by the image IF 64. For example, the processor 60 can recognize a state of work of the customer using a skeleton estimation technique such as Open Pose. In such a case, the processor 60 may detect the transition to the payment process by detecting a particular action of the customer instructing proceeding to the payment process.

If detecting that the checkout apparatus 2 proceeds to the payment process (YES in ACT 35), the processor 60 acquires, via the image IF 64, an image photographed by the security camera 4 when the checkout apparatus 2 proceeds to the payment process (ACT 36). The processor 60 checks whether any unregistered commodity is left in the image photographed by the security camera 4 when the processor 60 determines that the checkout apparatus 2 proceeds to the payment process (ACT 37).

For example, the processor 60 determines whether an unregistered commodity has been left behind on the first commodity placing table 11 (or other place where an unregistered commodity is to be placed) in the image photographed by the security camera 4 acquired by the image IF 64. The processor 60 may determine whether an unregistered commodity is left in a cart placed in the predetermined position. The processor 60 can make the determination about whether an unregistered commodity is left using an object detecting technique such as SSD (Single Shot Detector). The processor 60 may make the determination about whether an unregistered commodity is present using an identification technique such as AlexNet (or a convolutional neural network).

After determining that an unregistered commodity is left behind (YES in ACT 38), the processor 60 acquires the image photographed by the security camera 4 (ACT 39) and checks whether the checkout apparatus 2 proceeds to the commodity registration process (ACT 40). For example, the processor 60 may receive via the communication IF 66, a signal indicating the transition to the commodity registration process from the checkout apparatus 2. In such a case, the processor 60 determines, based on the signal indicating the transition to the commodity registration process, that the checkout apparatus 2 proceeds to the commodity registration process.

The processor 60 may detect, according to the transition of a screen displayed on the display 21 of the checkout apparatus 2, that the checkout apparatus 2 proceeds to the commodity registration process. The processor 60 may detect, by recognizing an action of the customer using an image analysis for the photographed image, that the checkout apparatus 2 proceeds to the commodity registration process.

If the checkout apparatus 2 does not proceed to the commodity registration process (NO in ACT 40), the processor 60 checks whether the customer who has made the payment is present in the work area (ACT 41). For example, the processor 60 analyzes the image acquired from the security camera 4 to thereby check whether the customer is present in the work area. For example, the processor 60 may determine, using the skeleton estimation technique such as Open Pose or the object detection technique such as SSD, whether the customer is present in the work area.

The processor 60 determines whether the customer is present in the work area (ACT 42). If determining that the customer is present in the work area (YES in ACT 42), the processor 60 returns to ACT 39 and repeatedly executes the processing in ACTS 39 to 42. That is, if the checkout apparatus 2 proceeds to the commodity registration process while the customer is present in the work area (YES in ACT 40), the processor 60 returns to ACT 34. As a result, the processor 60 can prevent an alert from being output against an act of the customer, who has made the payment but remains in the work area to newly start the registration process and the payment process for remaining commodities.

If determining that the customer is not present in the work area (NO in ACT 42), the processor 60 saves a series of image data acquired from when the customer entered the work area until when the customer left the work area (ACT 43). For example, the processor 60 extracts, from the storage device 63 that continuously stores images photographed by the camera 4, a series of images from when the customer entered the work area until when the customer left the work area. The processor 60 stores in the storage device 63 the series of images for future use.

If determining that the customer is not present in the work area (NO in ACT 42), the processor 60 issues an alert signal in order to notify a store clerk that there is the customer who left the work area while leaving the unregistered commodity (ACT 44). For example, the processor 60 outputs the alert signal to the attendant terminal 5. In such a case, the attendant terminal 5 displays, in response to the notification of the alert from the image analysis apparatus 3, on the display 90, a popup image indicating that there is the customer who left the work area while leaving the unregistered commodity. The processor 60 may control the communication IF 66 to transmit a photographed image of the customer to the attendant terminal together with the alert signal. In such a case, the attendant terminal 5 may display the photographed image including the customer on the display 90.

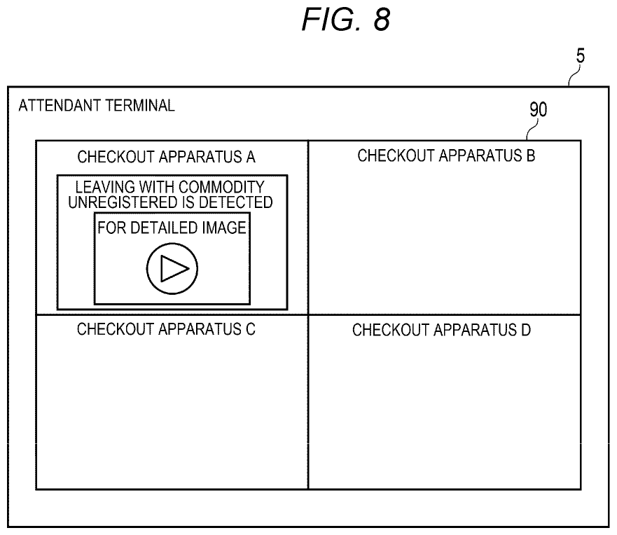

FIG. 8 is an example of a notification screen displayed on the attendant terminal 5.

In the display example illustrated in FIG. 8, the attendant terminal 5 monitors four checkout apparatuses 2 as monitoring targets. In the display example illustrated in FIG. 8, the display 90 displays four divided monitoring screens corresponding to the four checkout apparatuses 2 (e.g., checkout apparatuses A, B, C, and D).

If a customer left the work area while leaving an unregistered commodity in the checkout apparatus A, the display 90 displays an alert on the monitoring screen corresponding to the checkout apparatus A. In the display example illustrated in FIG. 8, a window for displaying a photographed image together with an alert message “leaving with commodity unregistered is detected” is displayed on the monitoring screen of the checkout apparatus A.

A play button for instructing display of an image is displayed in the window. If an administrator such as a store clerk presses the play button, the processor 80 of the attendant terminal 5 causes the display 90 to display in the window one more images showing the customer acquired from the image analysis apparatus 3. For example, the images are a series of photographed images from when the customer entered the work area until when the customer left the work area. In such a case, the processor 80 may cause the display 90 to continuously display the series of images in chronological order.

The processor 60 may notify the alert to a portable terminal carried by a store clerk or a security guard. The processor 60 may control the communication IF 66 to transmit an email including the notification of the alert to a predetermined mail address (for example, a mail address of the store clerk). Further, the processor 60 may control the display 21 to flash to notify the alert.

As explained above, the image analysis apparatus 3 acquires, from the security camera 4, one or more images of the photographing region including the work area in which the registration and payment processes are performed by the customer using the checkout apparatus 2. If the payment is made in a state in which there is any unregistered commodity, the image analysis apparatus 3 monitors the customer's activity and determine whether he or she is present in the work area. If determining that the customer left the work area in the state in which an unregistered commodity is present, the image analysis apparatus notifies an alert to the attendant terminal 5.

Consequently, it is possible to allow, without notifying, every time the payment process ends, an alert to a customer who is about to repeat the registration and payment processes for the purpose of splitting the transaction and receiving separate receipts. If a customer leaves the work area in a state in which a commodity is unregistered, it is possible to issue a warning against unauthorized use by notifying an alert to the attendant terminal 5 and keep security.

The several embodiments are explained above. However, these embodiments are presented as examples and are not intended to limit the scope of the invention. These new embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

What is claimed is:

1. An image analysis apparatus, comprising:
a first interface connectable to a camera configured to capture an image of a predetermined area in which registration and payment processes for one or more commodities to be purchased are performed using a checkout apparatus; and
a processor configured to
when the payment process is performed, determine whether an unregistered commodity is present in the area using the image,
upon determining that an unregistered commodity is present in the area, determine whether a customer is present in the area, and
upon determining that the customer is not present in the area, output an alert signal.

2. The image analysis apparatus according to claim 1, further comprising:
a memory, wherein
the processor is further configured to:
determine whether the customer has entered the area before the registration and payment processes are performed, and
upon determining that the customer has entered the area, control the camera to continue to capture the image of the area and store the image in the memory until the customer is determined to be not present in the area.

3. The image analysis apparatus according to claim 2, further comprising:
a network interface configured to communicate with an attendant terminal, wherein
the processor is further configured to, upon determining that the customer is not present in the area, control the network interface to transmit to the attendant terminal the alert signal and the image continuously captured by the camera after the customer has entered the area.

4. The image analysis apparatus according to claim 2, wherein the processor is further configured to:
determine whether the checkout apparatus proceeds to the payment process, and
upon determining that the checkout apparatus proceeds to the payment process, determine whether an unregistered commodity is present in the area.

5. The image analysis apparatus according to claim 4, wherein the processor is further configured to determine whether the checkout apparatus proceeds to the payment process based on the image captured by the camera.

6. The image analysis apparatus according to claim 1, wherein the processor is further configured to output the alert signal to the checkout apparatus, the alert signal causing a display of the checkout apparatus to display an alert.

7. The image analysis apparatus according to claim 1, wherein the area includes a first table disposed adjacent to the checkout apparatus and on which one or more unregistered commodities are placed.

8. The image analysis apparatus according to claim 7, wherein the area further includes a second table disposed adjacent to the checkout apparatus and on which one or more registered commodities are placed.

9. The image analysis apparatus according to claim 8, wherein the area further includes a predetermined position in which a cart storing one or more commodities is placed.

10. The image analysis apparatus according to claim 1, wherein the camera is disposed on the checkout apparatus.

11. A monitoring system, comprising:
an attendant terminal including a display; and
an image analysis apparatus including:
a first interface connectable to a camera configured to capture an image of a predetermined area in which registration and payment processes for one or more commodities to be purchased are performed using a checkout apparatus, and
a processor configured to
when the payment process is performed, determine whether an unregistered commodity is present in the area using the image,
upon determining that an unregistered commodity is present in the area, determine whether a customer is present in the area, and
upon determining that the customer is not in the area, output a signal that causes the display of the attendant terminal to display an alert.

12. The monitoring system according to claim 11, wherein
the image analysis apparatus further includes a memory, and
the processor is further configured to:
determine whether the customer has entered the area before the registration and payment processes are performed, and
upon determining that the customer has entered the area, control the camera to continue to capture the image of the area and store the image in the memory until the customer is determined to be not present in the area.

13. The monitoring system according to claim 12, wherein the processor is further configured to, upon determining that the customer is not present in the area, output to the attendant terminal the image continuously captured by the camera after the customer has entered the area.

14. The monitoring system according to claim 12, wherein the processor is further configured to:
determine whether the checkout apparatus proceeds to the payment process, and
upon determining that the checkout apparatus proceeds to the payment process, determine whether an unregistered commodity is present in the area.

15. The monitoring system according to claim 14, wherein the processor is further configured to determine whether the checkout apparatus proceeds to the payment process based on the image captured by the camera.

16. The monitoring system according to claim 11, wherein the attendant terminal is configured to display the alert by flashing the display.

17. The monitoring system according to claim 11, wherein the area includes a first table disposed adjacent to the checkout apparatus and on which one or more unregistered commodities are placed.

18. The monitoring system according to claim 17, wherein the area further includes a second table disposed adjacent to the checkout apparatus and on which one or more registered commodities are placed.

19. The monitoring system according to claim 18, wherein the area further includes a predetermined position in which a cart storing one or more commodities is placed.

20. A checkout system, comprising:
a checkout apparatus configured to perform registration and payment processes for one or more commodities to be purchased; and
an image analysis apparatus including:
a first interface connectable to a camera configured to capture an image of a predetermined area in which the checkout apparatus is disposed, and
a processor configured to
when the payment process is performed, determine whether an unregistered commodity is present in the area,
upon determining that an unregistered commodity is present in the area, determine whether a customer is present in the area, and
upon determining that the customer is not present in the area, output an alert signal.
